(19) United States
(12) Patent Application Publication
(10) Pub. No.: US 2008/0177794 A1
(43) Pub. Date: Jul. 24, 2008

(54) STREET QUALITY ASSESSMENT METHOD AND SYSTEM

(76) Inventors: Adam John SPENCER, Richmond (AU); Jason Vernon Spencer, Richmond (AU)

Correspondence Address: Pearl Cohen Zedek Latzer, LLP, 1500 Broadway, 12th Floor, New York, NY, 10036, US

(21) Appl. No.: 12/015,164

(22) Filed: Jan. 16, 2008

(30) Foreign Application Priority Data
Jan. 16, 2007 (AU) 2007900193

(51) Int. Cl. G06F 15/16; G06F 17/30

(52) U.S. Cl. 707/104.1; 709/201; 707/E17.009

(57) ABSTRACT

A computer-implemented method and system for providing an assessment of the quality or desirability of a street includes determining a plurality of assessment parameters, each parameter being associated with one or more characteristics which influence an overall perceived quality of a street. The method enables a user to select a street for review, and subsequently presents the user with the plurality of assessment parameters. A plurality of user scores corresponding to the assessment parameters are received from the user and combined with the corresponding scores of other users to produce a combined score for each of the assessment parameters. An importance weighting factor is applied to the combined score to generate a weighted score for each of the assessment parameters and a determination of the street score representing an overall assessment of the quality of the street is obtained by combining the weighted scores. The method may be implemented within a variety of online systems, including web-based servers, user terminals, messaging systems, mobile communications systems and the like.

### PRIOR APPLICATION DATA

The present application claims priority from prior Australian application 2007900193 filed Jan. 16, 2007, incorporated by reference herein in its entirety.

### FIELD OF THE INVENTION

The present invention relates generally to computerised information systems. In particular, the invention concerns a method and system for providing an assessment of the quality or desirability of a street. The invention is most readily implemented on the Internet and it will therefore be convenient to describe the invention in that environment. It should be understood however that the invention may be implemented in other environments.

### BACKGROUND OF THE INVENTION

Today, it is not possible to discover detailed information about the many characteristics that determine the quality of a street. Typically the only information available is provided by real estate agents and this is usually highly focused on a house or the city in which the house is located. People live in streets first, and neighbourhoods second. People care most about the people living in their surrounding houses, not those 5 miles away.

Street level information is highly valuable as a tool to help people make informed decisions on which street to live in, and for existing residents to unlock “inside” information about the various services on offer.

Some of the many complaints heard which inspired the present invention include:
If only I knew what my street was like before I bought the house!
I like my house, but my street is so noisy.
My street is full of nosy neighbours!
My realtor/real estate agent thinks it's an amazing street—but does he really know?
I've just moved into the street—anything I should know?
Can I get mobile/cell phone reception in the street?
Who has the best Chinese food in my local area?

Looking forward, if a person were considering buying/renting a home in a particular street and a web site gave inside, relevant information on the street (good or bad), a large proportion of people would find this information useful.

### SUMMARY OF THE INVENTION

Embodiments of the present invention are aimed generally at facilitating the collection, analysis and/or dissemination of street level information. More particularly, at delivering to users a more accurate assessment of the quality of a street based on information provided by other users.

One aspect of the present invention accordingly provides a computer-implemented method of providing an assessment of quality of a street. The method comprises the steps of:

determining a plurality of assessment parameters, each parameter being associated with one or more characteristics which influence an overall perceived quality of a street;

enabling a user to select a street for review;

presenting to the user the plurality of assessment parameters;

receiving from the user a plurality of scores corresponding with said assessment parameters;

combining the plurality of user's scores with corresponding scores of other users to produce a combined score for each of the assessment parameters;

applying an importance weighting factor to the combined score to generate a weighted score for each assessment parameter; and

determining a street score representing an overall assessment of the quality of the street by combining the weighted scores.

In this context, the term “quality” is intended to encompass all of the characteristics of a street, or its people or location, which might make the street desirable to live in. Some examples might include the neighbourly spirit, the surrounding facilities such as restaurants and shopping outlets, noise levels, or access to public transport.

These characteristics may be defined by a number of assessment parameters which are associated with identified characteristics. In developing the presently preferred form of the invention, the inventors have identified 22 assessment parameters, falling within five broad categories, which determine the quality of a street. The five broad categories preferably include characteristics relating to street atmosphere, telecommunications, health and safety, financial considerations and essential services. It should be understood however than any number of assessment parameters, potentially divided into any number of categories, may alternatively be used.

The invention is preferably implemented in an Internet environment, in the form of a web site which facilitates the collection of data from people that have a residential relationship (e.g. currently live or may have lived previously) to a street, as well as those people that have a non-residential relationship (e.g. visitors or real estate professionals) to a street. Preferably the web site enables users, such as those having a residential or non-residential relationship to the street, to post “reviews”. The basic form of the web site may thus be somewhat similar to consumer review web sites such as www.consumerreview.com or www.epinions.com which provide product ratings based on user feedback. To date, there has been no similar site for providing ratings for residential streets.

Also, unlike normal consumer product reviews, the present inventors have realized that not all characteristics of the streets in which people live are of equal importance to them. Some characteristics have a greater influence on the overall assessment of street quality than others. The inventors have therefore recognized that these characteristics should be given a greater weighting than other characteristics. Thus, in calculating an overall street score, the present invention includes a weighting factor applied to each of the characteristics, or assessment parameters.

The web site may also provide a forum for sharing opinions and local information on streets in the neighbourhood, city or country. The web site may thus serve as a valuable information resource, and communication tool, for the residents of each street.

In one embodiment of the invention, the streets within a specified locality may be ranked based on their street scores so as to produce a street rank for each street. The street rank for the selected street, or a ranking derived from the street rank, may then be displayed to the user, either together with the street score or instead of the street score.

In a preferred embodiment, the method also comprises a step of applying an equalisation value to the street score to produce a final street score. The equalisation value is preferably based on the number of assessment parameters being scored. In this way, a common basis for comparison can be used for all streets.

Advantageously, in the preferred embodiment, the step of combining the users' scores comprises removing a percentage of the highest and lowest scores, and averaging the remaining scores. This truncation of the raw scores thereby produces a truer representation of a mean score by eliminating the extremes.

In one embodiment of the invention, the importance weighting factors are based on a survey of a cross section of typical residents to determine relative importance of each assessment parameter. An importance ranking may be assigned to each of the assessment parameters by averaging the survey results and then assigning a numerical importance ranking to each one of the assessment parameters according to its average result relative to the average results corresponding with other assessment parameters. The weighting factor for each assessment parameter may then be based on the importance ranking of the assessment parameter.

Preferably, a calculation of the importance weighting factor for each assessment parameter comprises dividing the importance ranking of the assessment parameter by the total number of assessment parameters being ranked.

In a preferred embodiment, the step of combining the user's scores with corresponding scores of other users to produce a combined score, may also comprise applying a relationship weighting factor to the user's scores in accordance with a predetermined relationship of the user to the street. This predetermined relationship may be selected from a residential relationship and a non-residential relationship. The non-residential relationship may be selected from a visitor relationship and a professional relationship.

Advantageously, in the preferred embodiment, the step of combining the user's scores with corresponding scores of other users to produce a combined score may also comprise receiving from the user an indication of the user's relationship to the street being reviewed. The step of combining the user's scores with corresponding scores of other users to produce a combined score may comprise combining the user's scores with the scores of other users having the same relationship to the street being reviewed, to produce a corresponding combined score for each of the assessment parameters. Furthermore, the step of determining the street score representing an overall assessment of the quality of a street may comprise combining the weighted scores of users having the same relationship to the street being reviewed.

In one embodiment of the invention, the step of determining a street score may also comprise the steps of determining a difference between the street score of users having a residential relationship with the street being reviewed and the street score of users having a non-residential relationship with the street being reviewed; and calculating a discount to be applied to the street score by determining the product of the difference and a predefined weighting corresponding to the non-residential relationship to the street being reviewed.

Preferably, the ranking of streets within a specified locality may also comprise the steps of applying one or more adjustment factors to the street score for each of the streets within the specified locality, determining the ranking value of the street in relation to all streets within the specified locality by using the adjusted street scores to produce a final street rank for each street, and then outputting the final street rank for the selected street.

The adjustment factors may comprise modifiers based on any one or more of the following considerations:
the number of users who have submitted scores for the street;
the average age of the scores submitted for the street;
whether the users submitting the scores were part of a membership group;
whether the users submitting the scores have contributed additional value in the ranking process.

In a preferred embodiment, the method also comprises the steps of enabling a user to read a written review provided by another user and submit an indication of whether the review has been either helpful or unhelpful, allocating a discount percentage by calculating a ration of unhelpful to helpful indications submitted by a plurality of users; and applying a discount to scores of the user who provided the written review.

In this context, the term “discount” is used to indicate some deduction from the full amount or value.

Another aspect of the invention provides a computer-implemented system adapted to implement the above described method of providing an assessment of quality of a street based on the assessment parameters and associated corresponding characteristics which influence the overall perceived quality of a street. The computer-implemented system comprises:

means for enabling a user to select a street for review;

means for presenting to the user the plurality of assessment parameters;

means for receiving from the user a plurality of scores corresponding with said assessment parameters;

means for combining the plurality of user's scores with corresponding scores of other users to produce a combined score for each of the assessment parameters;

means for applying an importance weighting factor to the combined score to generate a weighted score for each assessment parameter; and

means for determining a street score representing an overall assessment of the quality of the street by combining the weighted scores.

In accordance with preferred embodiments, the system may comprise one or more application servers and/or one or more database servers connected via a communications network, such as the Internet, to a client computer. The servers execute computer readable program code to implement the above described means.

A further aspect of the invention provides a computer-implemented system adapted to implement the above described method of providing an assessment of quality of a street based on the assessment parameters and associated corresponding characteristics which influence the overall perceived quality of a street, the system comprising one or more computers comprising:

at least one processor;

an interface between said processor and a data network;

a database for containing information relating to user assessment of street quality; and

at least one storage medium operatively coupled to the processor, the storage medium containing program instructions for execution by the processor, said program instructions causing the processor to execute the steps of:
enabling a user to select a street for review;
presenting to the user the plurality of assessment parameters;
receiving from the user a plurality of scores corresponding with said assessment parameters via the data network;
combining the plurality of user's scores with corresponding scores of other users to produce a combined score for each of the assessment parameters;
applying an importance weighting factor to the combined score to generate a weighted score for each assessment parameter;
determining a street score representing an overall assessment of the quality of the street by combining the weighted scores;
storing in the database information relating to said scores, said combined scores, said weighted scores and/or said street score; and
outputting the street score via the data network.

In a preferred embodiment of the invention, the program instructions cause the processor to receive from the user an indication of the user's relationship to the street being reviewed via a data network and to store this indication in the database.

Preferably, the program instructions may further cause the processor, in the step of determining a street score, to derive from the database a street score of users having a residential relationship with the street being reviewed, as well as a street score of users having a non-residential relationship with the street being reviewed. A relationship weighting factor may then be applied to a difference between the street score of users having a residential relationship and the street score of users having a non-residential relationship in order to calculate a discount which is applied to the street score of users having a non-residential relationship to the street being reviewed.

Advantageously, the program instructions may further cause the processor to receive from a user a written review of a selected street via a data network and store the written review in the database. The program instructions may also cause the processor to retrieve from the database a written review provided by another user and output the written review via the data network for presentation to a user.

A still further aspect of the invention provides a tangible computer-readable medium having computer-executable instructions stored thereon for performing a method for providing an assessment of quality of a street based on a predetermined plurality of assessment parameters associated with corresponding characteristics influencing the overall perceived quality of a street, the method comprising the steps of:

enabling a user to select a street for review;

presenting to the user the plurality of assessment parameters;

receiving from the user a plurality of scores corresponding with said assessment parameters;

combining the plurality of user's scores with corresponding scores of other users to produce a combined score for each of the assessment parameters;

applying an importance weighting factor to the combined score to generate a weighted score for each assessment parameter; and

determining a street score representing an overall assessment of the quality of the street by combining the weighted scores.

A preferred embodiment of the present invention will now be described with reference to the accompanying drawings. It should be understood that this embodiment is given by illustration only and the invention is not limited to this preferred embodiment.

### BRIEF DESCRIPTION OF THE DRAWINGS

In the drawings:

FIG. 1 shows a schematic block diagram of a system for providing an assessment of quality of a street in accordance with a preferred embodiment of the present invention;

FIG. 2 is a flow chart illustrating a preferred method of providing an assessment of quality of a street in accordance with the invention;

FIG. 3 is a flow chart illustrating the statistical measures applied to combined scores FIG. 2, in accordance with a preferred embodiment of the invention;

FIG. 4 illustrates a sample set of survey data for creating weighting factors applicable to the assessment parameters used in a preferred form of the method of the present invention;

FIG. 5 illustrates the ranking process for creating the weighting factors;

FIG. 6 illustrates the final weighting calculations;

FIG. 7 illustrates one example of a suitable web site home page;

FIG. 8 illustrates an example street review web page;

FIG. 9 illustrates an example of a web page for writing a review;

FIG. 10 illustrates an example street review web page including an option for the user to indicate their relationship to the selected street.

FIGS. 11A and 11B illustrate a sample set of user review scores and one example of a method for calculating a street score;

FIG. 12 illustrates an example of an output display of the final street score;

FIG. 13 illustrates the weightings that are applied to street scores according to the relationship with the street.

FIGS. 14A and 14B illustrate one example of a method for calculating a street rank;

FIG. 15 illustrates an example of an output display of the final street rank; and

FIG. 16 illustrates the discount factors to be applied to user's scores.

### DETAILED DESCRIPTION OF PREFERRED EMBODIMENT

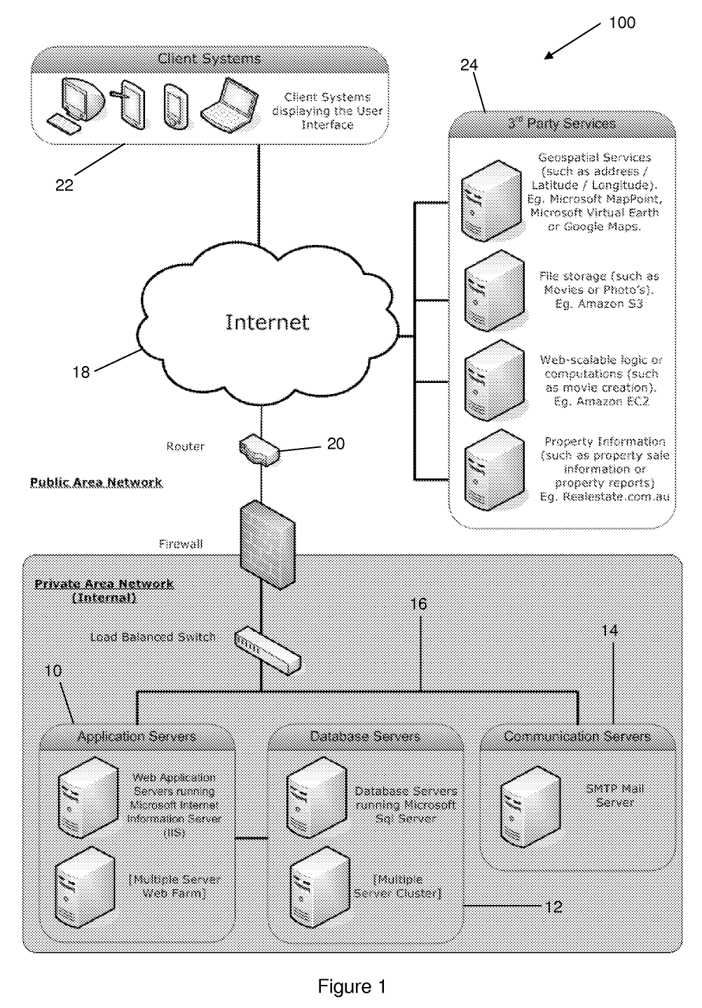

Referring now to the drawings, FIG. 1 illustrates an exemplary system 100 in which preferred embodiments of the invention may be implemented. The system comprises one or more central application servers 10, a cluster of database servers 12 and communications servers 14 connected via a local area network 16. This network 16 is connected to the Internet 18 by a router 20. It will be appreciated that FIG. 1 depicts the system 100 schematically only, and is not intended to limit the technology employed in the servers, client systems and/or communication links. The application servers are primarily web application servers running Microsoft Internet Information Server (IIS) and execute computer program code which implements the method described below. The database servers are primarily running Microsoft SQL Server and process database queries from the web application servers. The communications servers are predominantly Simple Mail Transfer Protocol (SMTP) Mail Servers.

Client, or user, systems 22 are also connected to the Internet 18 for displaying web pages served by the application servers 10. The user systems 22 may be wired or wireless devices, and their connections to the network may utilize various technologies and bandwidths. For example, applicable client/user systems comprise (without limitation): PC's with wired (eg LAN, cable, ADSL, dial-up) or wireless (eg WLAN, cellular) connections; and wireless portable/handheld devices such as PDA's or mobile/cellular telephones. These devices also comprise input means, such as a mouse and keyboard, stylus or other pointing device, to enable the users to make selections and input data to the web pages. The protocols and interfaces between the user systems and the servers may also vary according to available technologies, and comprise (again without limitation): wired TCP/IP (Internet) protocols; GPRS, WAP and/or 3G protocols (for handheld/cellular devices); Short Message Service (SMS) messaging for digital mobile/cellular devices; and/or proprietary communications protocols.

A number of third party web services 24 are also utilised in order to facilitate certain elements of the system. These services comprise (but are not limited to) Geospatial Services (eg Microsoft MapPoint, Microsoft Virtual Earth and Google Maps) for providing images of maps and other geographical information, File Storage Services (eg Amazon S3) to act as a repository for data such as movies and photos, Web-Scalable Logic or Computation Services (eg Amazon EC2) for such tasks as movie creation, and Property Information Services (eg realestate.com.au) for providing information such as property reports and property sale information.

It should be appreciated that the hardware used to implement the method of the invention may be conventional in nature or specifically designed for the purpose. The hardware structure shown in FIG. 1 is merely one possible embodiment and any other suitable structure may be utilised.

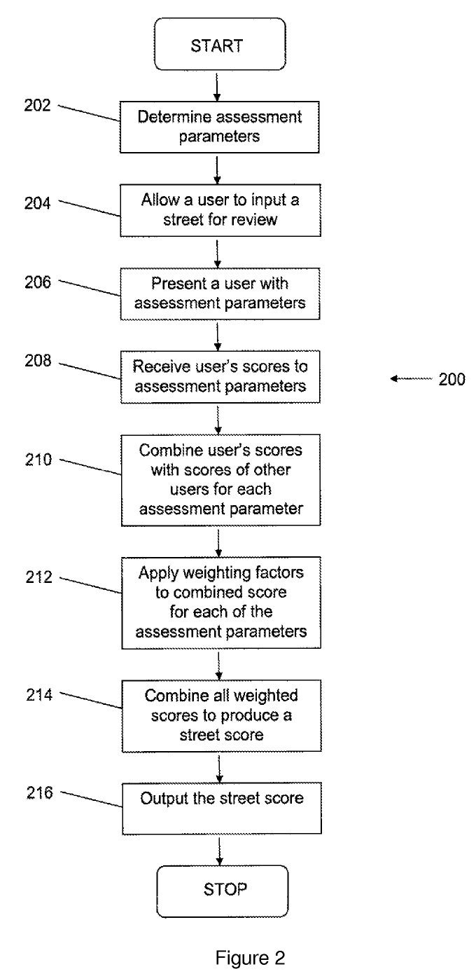

FIG. 2 is a flow chart 200 which illustrates a preferred method of providing an assessment of quality of a street in accordance with the present invention. In accordance with this general method, at step 202 the method requires a determination of certain assessment parameters which comprise characteristics relating to street atmosphere, telecommunications, health and safety, financial considerations and essential services. The present inventors have identified various characteristics, or assessment parameters, that determine the quality of a street. The assessment parameters have been grouped into five broad categories as follows:
1.StreetVibe
   Neighbourly Spirit
   Eating Out—restaurants & cafes
   Nightlife—quality bars, clubs
   Retail therapy—shopping in the area.
   Fitness—Quality Gyms, running tracks.
2.StreetWired
   Cell/Mobile Phone Reception
   Internet Access
   Pay TV Access
3.StreetHealth
   Peace & Quiet—Low Noise
   Lack of Traffic
   Safe & Sound—Low Crime, Police, Safety House
   Clean & Green—Litter, Waste
   Pest Free—Rats, possum, skunks etc
4.StreetValue
   Cost of Living—Rates & Taxes, Food, Utilities
   Resale/Rental Values—Value for money, Good resale
5.StreetEssentials
   Public Transport
   Medical Facilities—Doctors, Hospitals, Dental
   Schools
   Childcare
   Local Government—Quality of Services & Policies
   Power, Water, Gas
   Parks & Recreation—sports, picnic grounds, waterways

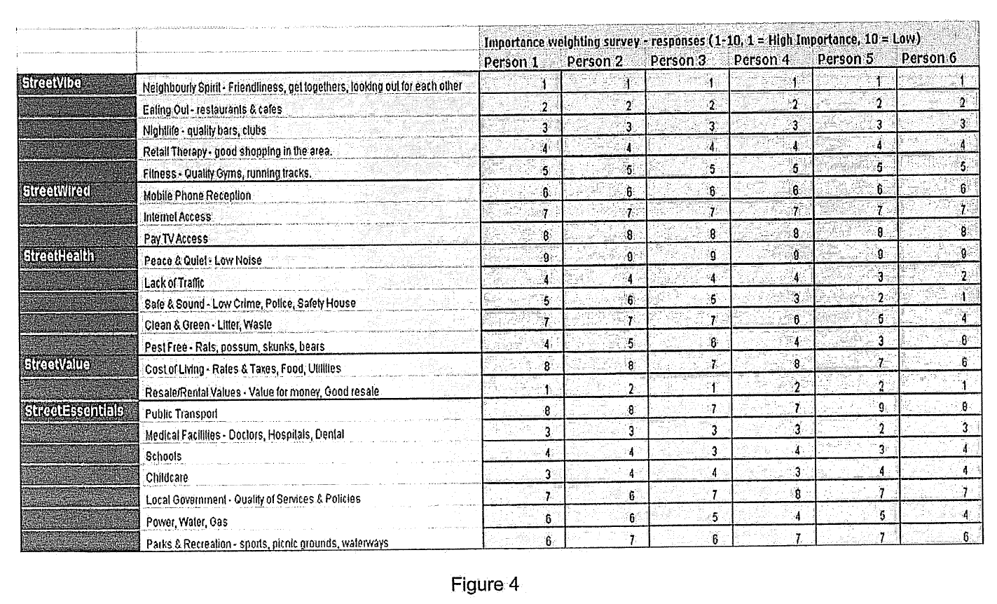

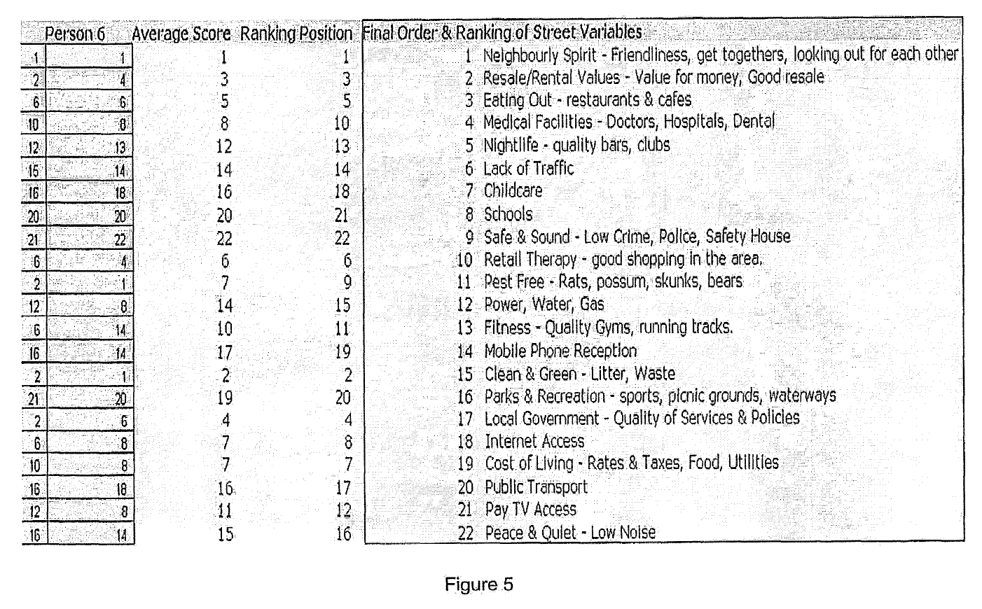

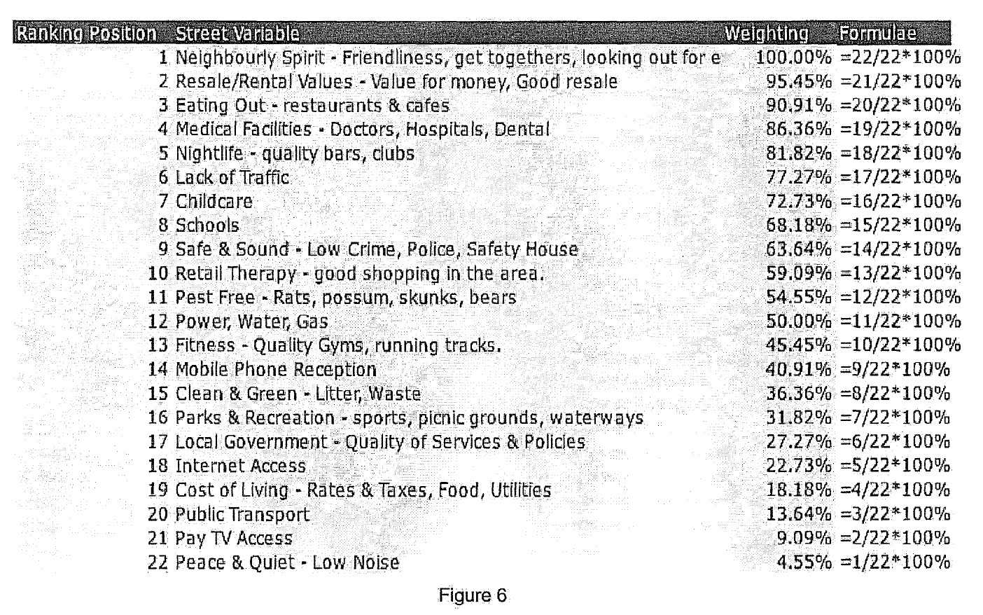

These assessment parameters are used in both the weightings and also the scoring model. Within each specified locality, a weighting index, namely a set of importance weighting factors which will be applied to the assessment parameters, is calculated to determine the importance of each of the assessment parameters relative to users within that specified locality. The importance weighting factors may be determined by interviewing a cross section of people and asking them to numerically rate the importance of each assessment parameter (eg 1=highest importance, 10=lowest importance). FIG. 4 illustrates how this information is collated. Once collated, the individual scores are then averaged (total score for an assessment parameter/number of people surveyed). Next, the average scores are sorted and then uniquely ranked from highest to lowest importance. This is illustrated in FIG. 5. The final weightings are calculated by taking the ranking position as a percentage of the total 22 possible assessment parameters, then multiplying by 100%. For example, the assessment parameter that ranked last, in position 22, receives only 1 out of 22 weighting. The assessment parameter that ranked highest receives the full 22 out of 22 weighting, or 100%. This is illustrated in FIG. 6.

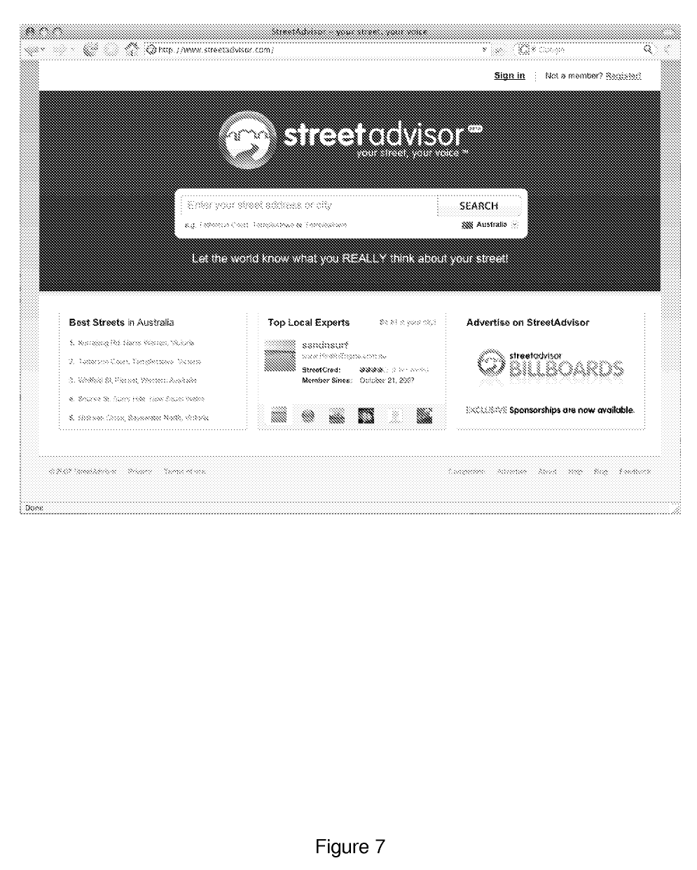

At step 204, the method allows the user to input a street for review. Collection of information from the user, and subsequent presentation of information to the user, is facilitated through a website. The user is presented with a homepage, one example of which is illustrated in FIG. 7.

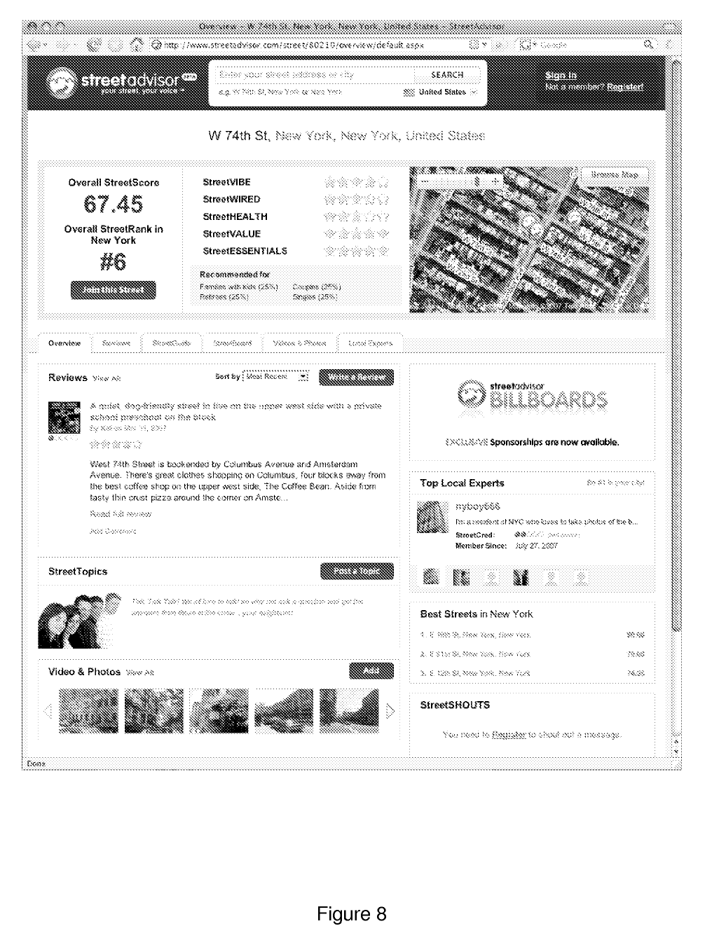

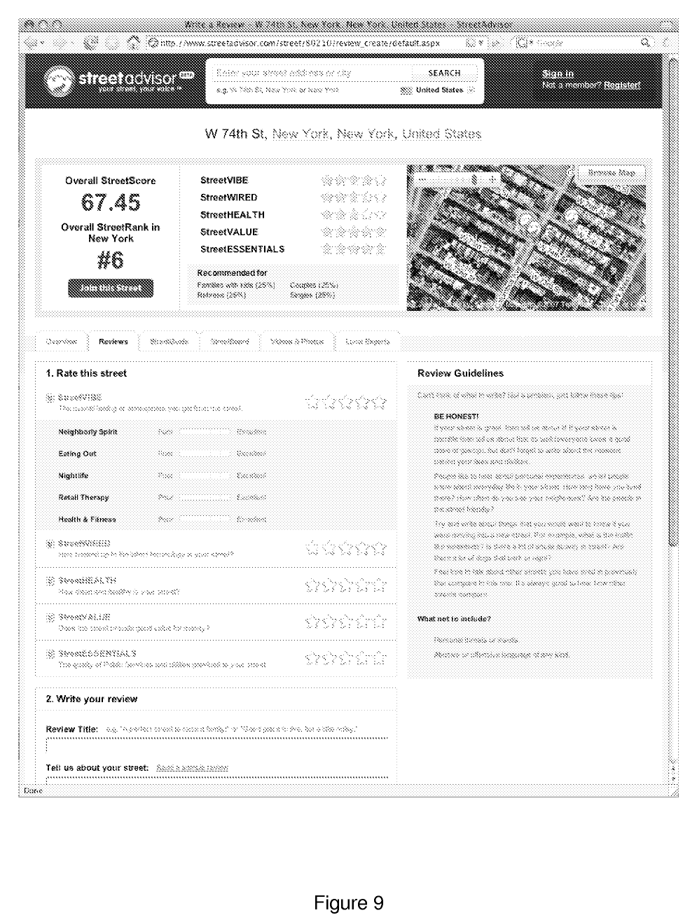

On the homepage the user will typically enter the address for the street that they wish to review. Depending on whether the street selected has been reviewed by other users, the user will be presented with the current street score and current street rank with the specified locality. Once this information is presented, as illustrated in FIG. 8, the user may click on the “Write a Review” button to open the data collection page illustrated in FIG. 9. In accordance with step 206, the user is presented with assessment parameters, and may then click on any one of the five categories (namely StreetVIBE, StreetWIRED, StreetHEALTH, StreetVALUE and StreetESSENTIALS) to open the category, as illustrated in FIG. 9, to expand the information under that category and show the variables, or assessment parameters, associated with that category. These assessment parameters are the same as those used in the survey process previously used to create the weighting index as described above.

At step 208, the system receives user scores in relation to the assessment parameters. In particular, each assessment parameter of the street score is rated, by the user, between 1 and 5, with 1 being the lowest quality score (e.g. very poor) and 5 being the highest (e.g. excellent). The user's scores are transmitted via the internet and then stored into a database.

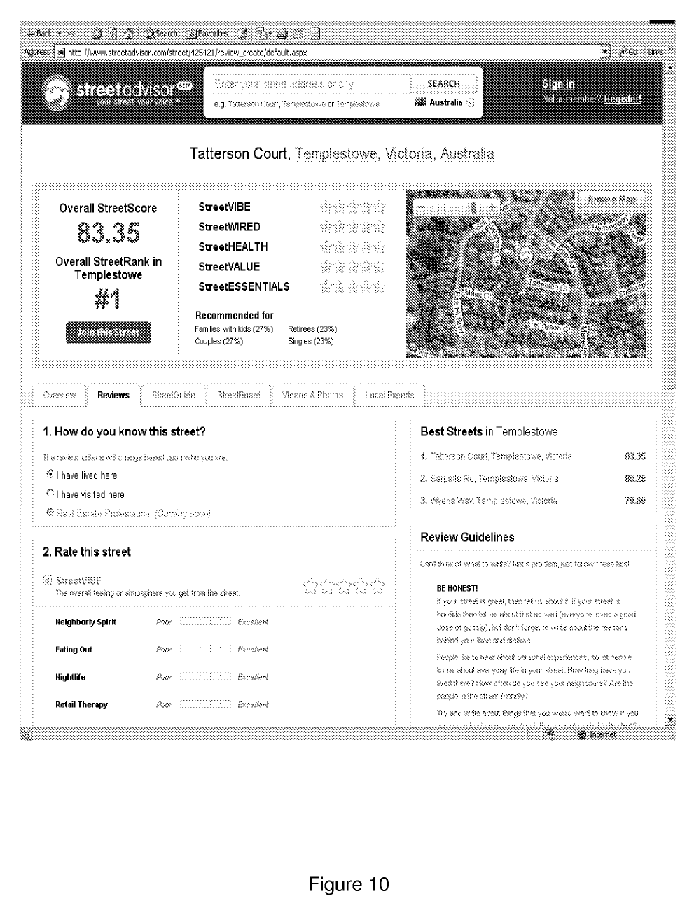

In accordance with an exemplary embodiment of the invention, at step 206 the user will also be required to indicate, as illustrated in FIG. 10, their relationship to the street under the title of “How do you know this street?”. The user will have the option of selecting whether their relationship to the street is residential in nature (eg selecting the “I have lived here” option) or non-residential in nature (eg selecting the “I have visited here” or “Real Estate Professional” option). A residential relationship comprises those users which currently live or have previously lived in the selected street. A non-residential relationship comprises users that have visited the street, or Real Estate Professionals that have some knowledge of the quality of the street. This indication by the user is transmitted along with the users scores via the internet and then stored into a database.

In a further preferred embodiment, at step 206 the user will also be presented with the option to provide a written review of the selected street by entering a “Review Title” and then entering some further text to provide an written assessment of the street. The user is also provided with the option of recommending the selected street for various demographics. The user is able to recommend the street for any one or more of the categories comprising (but not limited to) “Families with kids”, “Singles”, “Couples” and “Retirees”. The written information and recommendations by the user are transmitted along with the users scores via the internet and then stored into a database.

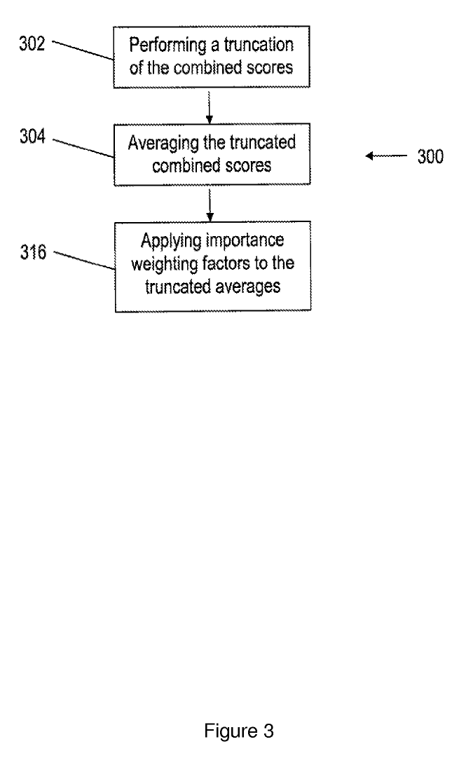

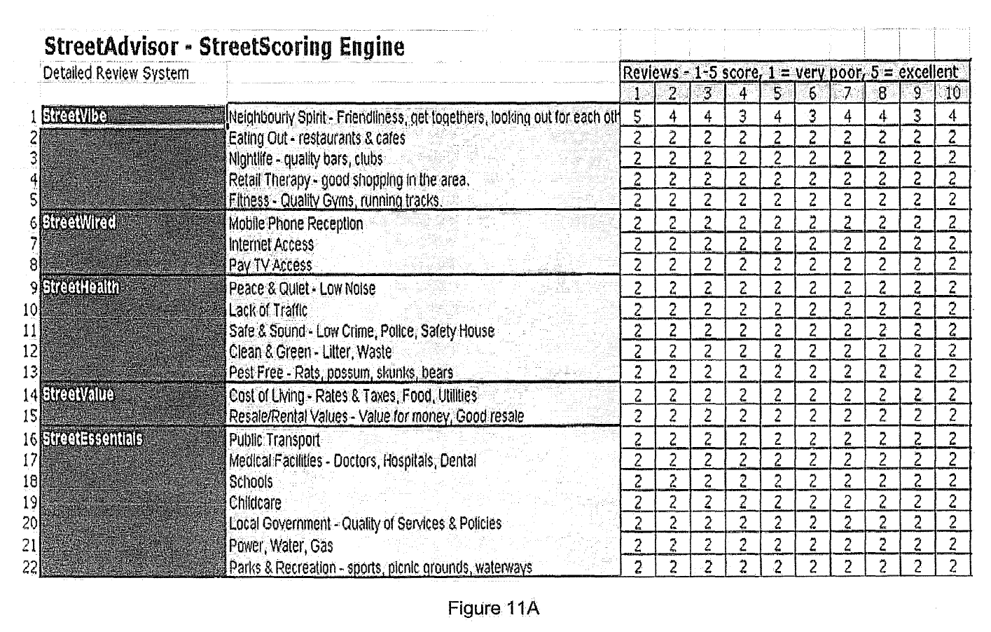

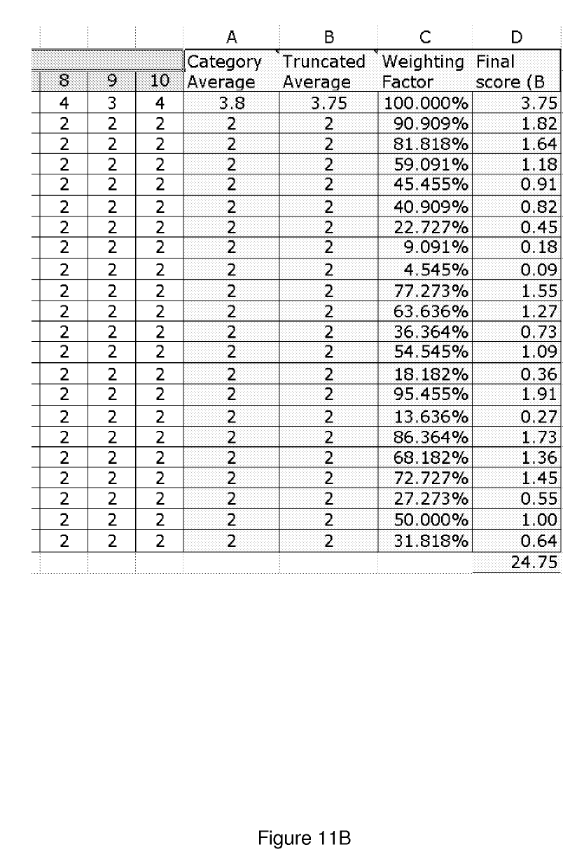

At step 210 the user's scores are combined with the scores of other users that have provided a review of the selected street to produce combined scores for each of the 22 assessment parameters. The importance weighting factors are then applied (step 212) to the combined scores for each of the assessment parameters. FIG. 3 is a flow chart 300 which illustrates the statistical measures required by steps 210 and 212 in accordance with one particularly preferred embodiment of the invention. Assuming a sample size of 10 people, an example set of data for 10 people which would be stored in the database is illustrated in FIG. 11A. A number of statistical measures are then performed, as illustrated in FIG. 11B, as follows:
1. At step 302, a percentage of the highest and lowest scores are removed (truncation) across each assessment parameter.
2. At step 304, the remaining scores for each assessment parameter are then averaged. (truncated average in column B of FIG. 11B)
3. At step 306, the truncated average of each assessment parameter (column B) is then multiplied by the weighting factor (column C). This gives the final, or weighted, score for each assessment parameter (column D).

At step 214, the weighted scores are combined, and in particular the sum of all of the final scores for all assessment parameters is calculated, giving a total score for the street (ie. a “street score”) out of 57.5 (24.75 in the example of FIG. 11B). The figure of 57.5 is the maximum score, taking into account the weighting factors, that could be achieved if every one of the assessment parameters was allocated a 5. An equalisation value is then applied to give a score out of 100. This equalisation value is 100/57.5 (1.73913) in the example.

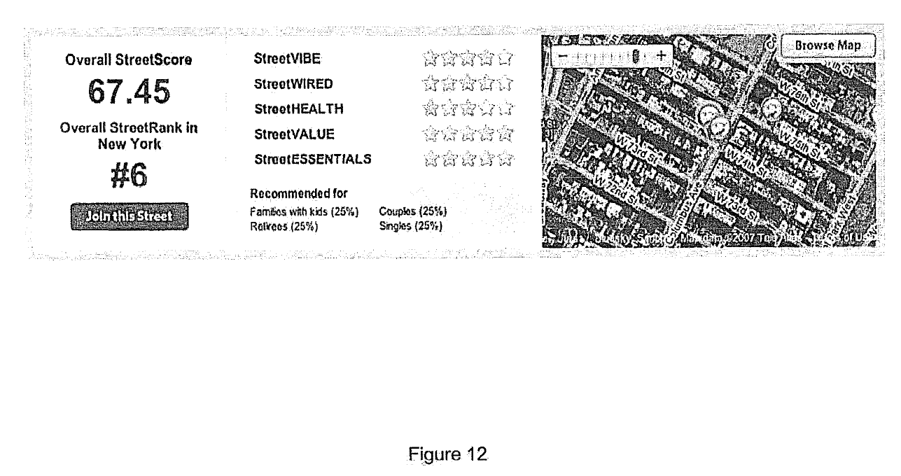

At step 216, the final “StreetScore” is displayed on the Review page (illustrated in FIG. 9 and in more detail in FIG. 12) along with the number of reviews (1 review shown in FIG. 8) that contributed to the score.

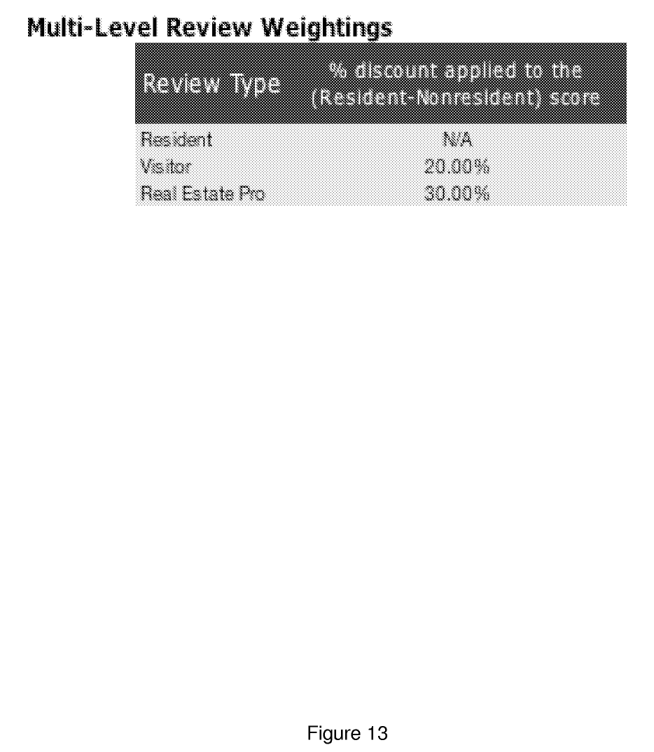

Alternatively or additionally, in some embodiments of the invention, a comparison is made between the combined street score of users having a residential relationship to the selected street and the combined street score of users having a non-residential relationship to the selected street, and a difference between the street scores is calculated. Depending on the relationship of the user to the selected street, a predetermined relationship weighting is applied to this difference. The predetermined relationship weightings are provided in the table shown in FIG. 13. The numerical amount that is produced represents the amount of discount to be applied to the combined street score for users having the same non-residential relationship with the selected street. For example, if the combined street score of users having a residential relationship is 100, and the combined street score of users having a non-residential relationship (eg Real Estate Professionals) is 50, then the difference between the scores is 50. The 30% relationship weighting for Real Estate Professionals is applied to the difference of 50 to produce an amount of 15. This amount is then subtracted from the combined street score of users having a residential relationship to produce a final street score of 85. However, if there have been no reviews by users having a residential relationship with the street being reviewed, then no discounts are applied.

Once a street score has been determined for a number of streets within a specified locality being considered, these street scores can then be used for ranking and comparing the quality of a street relative to other streets. The street ranking component of the scoring model is designed to show the position of a street ranked against all others in a postal/zip code (for example). In a further embodiment of the invention, the scoring model can be extended to produce a SuburbScore or CityScore by averaging all street scores within a specified suburb or city and applying certain weighting factors.

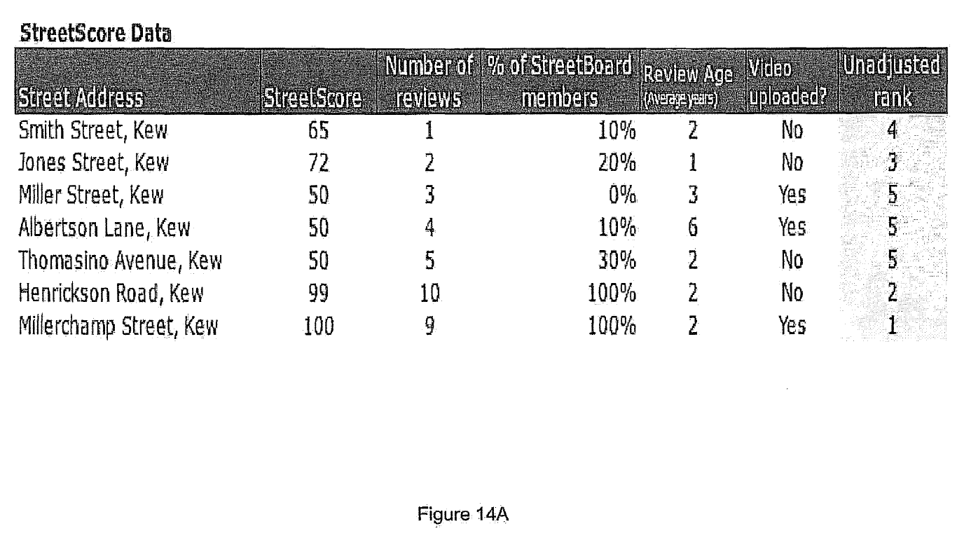

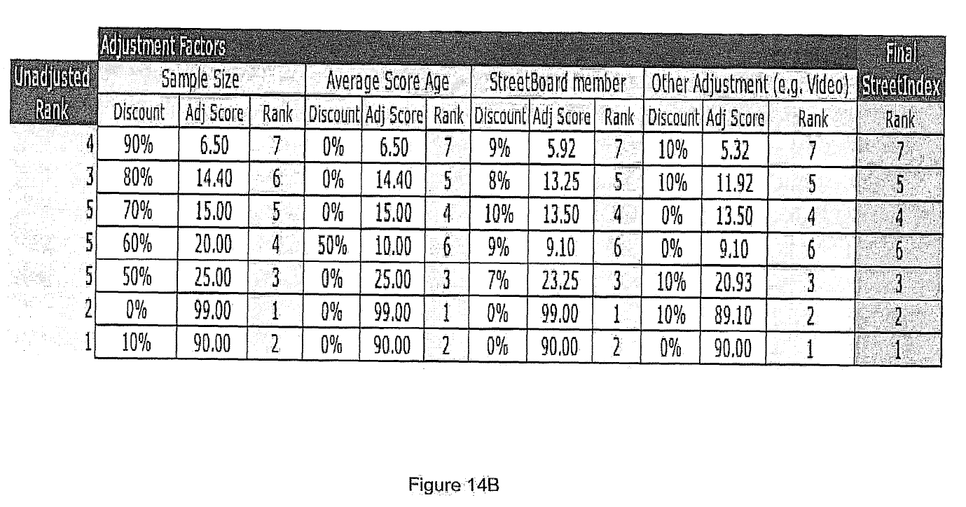

The final StreetScore calculation is used as the initial point of comparison. A set of sample scores is illustrated in FIG. 14A. Additional bonus point allocations, or discounts, are then included to take into account various differences that may exist between streets. This process is illustrated in FIG. 14B and described in more detail below.

Ranking adjustment factors include:
1. Sample size adjustment—the more reviews the higher accuracy
2. Age of review adjustment—recent reviews have more relevance than older reviews.
3. StreetBoard member adjustment—users that are also members (have joined) the street being reviewed are considered more likely to know the street than those that haven't joined the street. They are considered more likely to live at the applicable street address.
4. Other adjustments—anything that creates additional value to the review process receives an additional bonus factor. (e.g. uploading more content like photos, videos).
   Calculation methods:

The adjustment calculations, illustrated in FIG. 14B, are applied by taking the base StreetScore and then iteratively applying each adjustment factor. Discount factors are between 0% and 100% and can vary depending on each adjustment item. After each adjustment is processed the adjusted StreetScore is re-ranked.

Sample Size adjustment:
Base StreetScore*Sample Size adjustment discount. (e.g. 65*90%=6.50)
Fewer reviews equals more discount.
Once applied to all streets in the postal/zipcode, an amended ranking order (after sample size adjustment) is created.
   Average Score Age adjustment:
StreetScore (after Sample Size adjustment)*Average Score Age adjustment discount.
Once applied to all streets in the postal/zipcode, an amended ranking order (after Average Score Age adjustment) is created.
   StreetBoard Member adjustment:
StreetScore (after Average Score Age adjustment)*StreetBoard Member adjustment discount.
Once applied to all streets in the postal/zipcode, an amended ranking order (after StreetBoard Member adjustment) is created.
   Other adjustment:
StreetScore (after StreetBoard Member adjustment)*Other Adjustment discount.
Once applied to all streets in the postal/zipcode, a final StreetRank is determined.

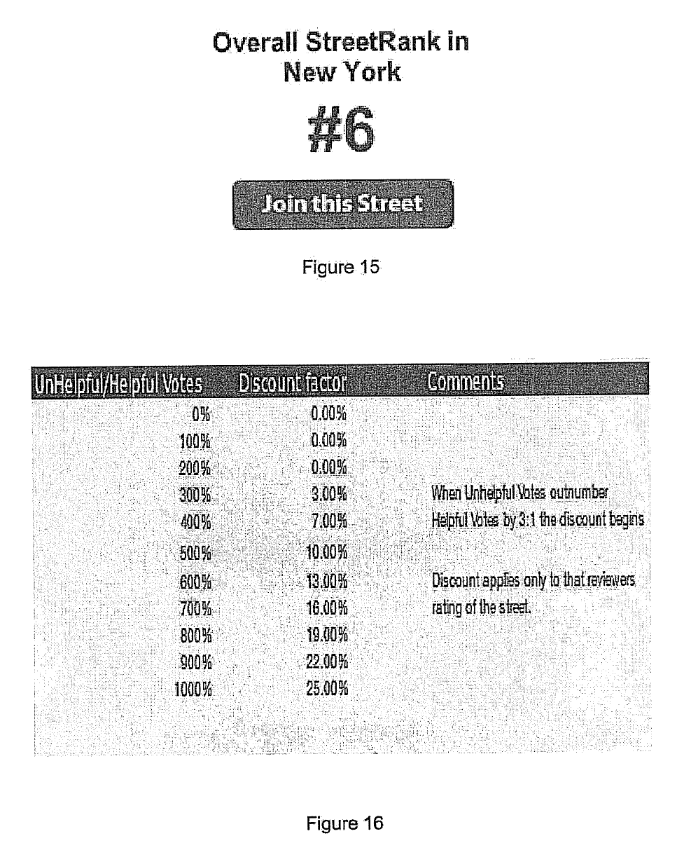

This is then displayed on the Review page (illustrated in FIG. 9 and in more detail in FIG. 15) alongside the baseline street score.

In a further preferred embodiment of the invention, a user is able to browse the written reviews conducted by other users in relation to the selected street. The user can then indicate, by clicking accordingly, whether the written review has been helpful or unhelpful. The indication by the user is transmitted via the internet and stored in the database. The ratio of unhelpful to helpful indications in relation to each review is maintained in the database. When this ratio exceeds a threshold limit (eg 3 to 1) a discount is applied to the user that provided the written review. Depending on the size of the ratio, the percentage of discount to be applied to the user's scores varies. FIG. 16 shows a table of discount percentages corresponding to the size of the ratio between unhelpful to helpful votes.

Although a preferred embodiment of the invention has been described herein in detail, it will be understood by those skilled in the art that variations may be made thereto without departing from the spirit of the invention or the scope of the appended claims.

1. A computer-implemented method of providing an assessment of quality of a street, the method comprising the steps of:
determining a plurality of assessment parameters, each parameter being associated with one or more characteristics which influence an overall perceived quality of a street;
enabling a user to select a street for review;
presenting to the user the plurality of assessment parameters;
receiving from the user a plurality of scores corresponding with said assessment parameters;
combining the plurality of user's scores with corresponding scores of other users to produce a combined score for each of the assessment parameters;
applying an importance weighting factor to the combined score to generate a weighted score for each assessment parameter; and
determining a street score representing an overall assessment of the quality of the street by combining the weighted scores.

2. The method of claim 1, further comprising the step of outputting the street score to at least one of a display, memory device or a data network.

3. The method of claim 1, further comprising the steps of:
determining a derived rating based upon the street score; and
outputting the derived rating to at least one of a display, a memory device or a data network.

4. The method of claim 3 wherein the derived rating is a ranking value of the street amongst streets in a specified locality.

5. The method of claim 1, further comprising the step of applying an equalisation value to the street score to produce a final street score, wherein said equalisation value is based on the number of assessment parameters being scored.

6. The method of claim 1 wherein the step of combining the plurality of users scores comprises removing a percentage of the highest and lowest scores, and averaging the remaining scores.

7. The method of claim 1 wherein the assessment parameters comprise characteristics relating to street atmosphere, telecommunications, health and safety, financial considerations and essential services.

8. The method of claim 1 wherein the importance weighting factors are based on a survey of a cross section of typical residents to determine relative importance of each assessment parameter.

9. The method of claim 8 wherein an importance ranking is assigned to each of the assessment parameters by:
averaging results of said survey; and
assigning a numerical importance ranking to each one of the assessment parameters according to its average result relative to the average results corresponding with other assessment parameters.

10. The method of claim 9 wherein the weighting factor for each assessment parameter is based on the importance ranking of the corresponding assessment parameter.

11. The method of claim 10 wherein a calculation of the importance weighting factor for each assessment parameter comprises dividing the importance ranking of the assessment parameter being considered by the total number of assessment parameters being ranked.

12. The method of claim 1 wherein the step of combining the plurality of the user's scores with corresponding scores of other users to produce a combined score, comprises applying a relationship weighting factor to the user's scores in accordance with a predetermined relationship of the user to the street.

13. The method of claim 12 wherein said predetermined relationship is selected from a residential relationship and a non-residential relationship.

14. The method of claim 13 wherein said non-residential relationship is selected from a visitor relationship and a professional relationship.

15. The method of claim 12, further comprising the step of receiving from the user an indication of the user's relationship to the street being reviewed, and wherein:
the step of combining the plurality of user's scores with corresponding scores of other users to produce a combined score comprises combining a plurality of user's scores with a plurality of scores of other users having the same relationship to the street being reviewed to produce a corresponding combined score for each of the assessment parameters; and
the step of determining a street score representing an overall assessment of the quality of the street comprises combining the weighted scores of users having the same relationship to the street being reviewed.

16. The method of claim 15 wherein the step of determining a street score further comprises the steps of:
determining a difference between the street score of users having a residential relationship with the street being reviewed and the street score of users having a non-residential relationship with the street being reviewed; and
calculating a discount to be applied to the street score by determining the product of said difference and a predefined weighting corresponding to the non-residential relationship to the street being reviewed.

17. The method of claim 4, which comprises the steps of:
applying one or more adjustment factors to the street score for each street amongst said streets in the specified locality;
determining the ranking value of the street amongst said streets in the specified locality based on said adjusted street scores to produce a final street rank for each street; and
outputting the final street rank for the selected street to at least one of a display, memory device or a data network.

18. The method of claim 17 wherein the adjustment factors for each street comprise modifiers based on any one or more of the following considerations:
the number of users who have submitted scores for the street;
the average age of scores submitted for the street;
whether users submitting scores were part of a membership group; and
whether users submitting scores have contributed additional value in the ranking process.

19. The method of claim 1, further comprising the steps of:
enabling the user to read a written review provided by another user and submit an indication of whether said review has been either helpful or unhelpful;
allocating a discount percentage by calculating a ratio of unhelpful to helpful indications submitted by a plurality of users; and
applying a discount to scores of the user who provided said written review.

20. A computer-implemented system for providing an assessment of quality of a street based on a predetermined plurality of assessment parameters associated with corresponding characteristics influencing the overall perceived quality of a street, the system comprising:
means for enabling a user to select a street for review;
means for presenting to the user the plurality of assessment parameters;
means for receiving from the user a plurality of scores corresponding with said assessment parameters;
means for combining the plurality of user's scores with corresponding scores of other users to produce a combined score for each of the assessment parameters;
means for applying an importance weighting factor to the combined score to generate a weighted score for each assessment parameter; and
means for determining a street score representing an overall assessment of the quality of the street by combining the weighted scores.

21. A computer-implemented system for providing an assessment of quality of a street based on a predetermined plurality of assessment parameters associated with corresponding characteristics influencing the overall perceived quality of a street, the system comprising one or more computers comprising:
at least one processor;
an interface between said processor and a data network;
a database for containing information relating to user assessment of street quality; and
at least one storage medium operatively coupled to the processor, the storage medium containing program instructions for execution by the processor, said program instructions causing the processor to execute the steps of:
enabling a user to select a street for review;
presenting to the user the plurality of assessment parameters;
receiving from the user a plurality of scores corresponding with said assessment parameters via the data network;
combining the plurality of user's scores with corresponding scores of other users to produce a combined score for each of the assessment parameters;
applying an importance weighting factor to the combined score to generate a weighted score for each assessment parameter;
determining a street score representing an overall assessment of the quality of the street by combining the weighted scores;
storing in the database information relating to said scores, said combined scores, said weighted scores and/or said street score; and
outputting the street score via the data network.

22. The system of claim 21 wherein said program instructions further cause the processor to receive from the user an indication of the user's relationship to the street being reviewed via a data network and store said indication in the database.

23. The system of claim 21 wherein said program instructions further cause the processor, in the step of determining a street score, to:
derive from the database a street score of users having a residential relationship with the street being reviewed;
derive from the database a street score of users having a non-residential relationship with the street being reviewed; and
apply a relationship weighting factor to a difference between the street score of users having said residential relationship and the street score of users having said non-residential relationship in order to calculate a discount which is applied to the weighted scores of the user to determine the street score.

24. The system of claim 21 wherein said program instructions further cause the processor to:
receive from a user a written review of a selected street via a data network;
store said written review in the database; and
retrieve from the database a written review provided by another user and output said written review via the data network for presentation to a user.

25. A tangible computer-readable medium having computer-executable instructions stored thereon for performing a method for providing an assessment of quality of a street based on a predetermined plurality of assessment parameters associated with corresponding characteristics influencing the overall perceived quality of a street, the method comprising the steps of:
enabling a user to select a street for review;
presenting to the user the plurality of assessment parameters;
receiving from the user a plurality of scores corresponding with said assessment parameters;
combining the plurality of user's scores with corresponding scores of other users to produce a combined score for each of the assessment parameters;
applying an importance weighting factor to the combined score to generate a weighted score for each assessment parameter; and
determining a street score representing an overall assessment of the quality of the street by combining the weighted scores.
